(19) United States
(12) Patent Application Publication
(10) Pub. No.: US 2003/0006881 A1
(43) Pub. Date: Jan. 9, 2003

(54) System and method for power line communication

(76) Inventor: Ronald R. Reyes, San Jose, CA (US)

Correspondence Address: George W. Gray, POWER LINE NETWORKS, 2362 Qume Drive, Suite D, San Jose, CA, 95131, US

(21) Appl. No.: 09/547,954

(22) Filed: Apr. 12, 2000

(51) Int. Cl. H04M 11/04

(52) U.S. Cl. 340/310.01; 340/310.03

(57) ABSTRACT

The present invention discloses a power line communication system and method for transmission of RF signals through an AC power line medium. The system includes a transmitter to transmit the RF signals through the AC power line medium and a receiver to receive the RF signals from the AC power line medium. The AC power line as a transmission medium is transparent to the circuits sending and receiving the RF signals.

### BACKGROUND OF THE INVENTION

The present invention relates to networking systems. More particularly, the present invention relates to a system and method for sending radio frequency (RF) signals using an AC power line as a transmission medium.

The demand for networking systems is increasing due to the increased use of computers in the work place as well as in the home. Furthermore, the convergence of computer, communications and entertainment systems technologies in devices used in the home is creating a new demand for a single network connecting computers, computer peripherals, telephones, modems, cable TV, television sets, computer controlled appliances, home automation and security systems. Alternative methods for networking include wireless networking, telephone wire networking, hard wire networking and power line networking.

Hardwire networking, such as with a coaxial cable, is generally considered the standard method for networking digital communications. This method requires the installation of a separate cable network throughout the industrial site or the home. Thus, hardwire networking requires additional wiring installation costs, and also does not accommodate the simultaneous transmission of computer data and analog TVs on the same network cable.

RF (Radio Frequency) Wireless networks typically transmit at frequencies between 900 MHz and 2.4 GHz over the air and are capable of transmitting video signals, audio signals and other data including computer digital data. However, RF Wireless networks suffer from bandwidth limitations so as not to create signal interference and violation of rules imposed by the FCC. IR (Infra Red) Wireless networks require line of sight operation, and are not easy to use for transmission between rooms in a building or home.

Telephone wire networks are currently being introduced to transmit data at about 10 Mbps rates. Although such telephone wire networks do not require new wiring, the network is limited to the number of telephone outlets available.

Power line communication (PLC) systems use an AC power line as a transmission medium. One advantage of power line communication systems over telephone wiring networks is that there are generally more power outlets available for connection than there are telephone outlets. Thus, the AC power line can be modeled as a homogenous wire which runs from the service drop throughout the building or home.

Conventional power line communication systems require proper handling of line noise and high frequency signals. The high frequencies and noise are constantly generated in the environment of the AC power line and are picked up by the line, thus presenting complex design issues to the PLC system designer.

A conventional power line communication system typically operates by superimposing a modulated carrier frequency on the AC signal carried on the power line. Generally, a conventional PLC system consists of a transmitter unit capable of adding the communication signal to the AC power line signal and a receiver unit capable of separating the communication signal from the AC power component signal.

In an ideal PLC system, the output signal of the receiver is a perfect copy of the signal, which was introduced to the transmitter. That is, the receiver ignores any signals (i.e., noise) which may impinge upon the system from a source other than the transmitter. The ideal PLC system should furthermore not become a source of noise either through direct transmission or by radiation.

Conventional PLC systems are typically used at relatively low carrier frequencies of 160 Kilohertz (kHz) to 455 Kilohertz (kHz). Some may utilize a frequency as high as 1.5 Megahertz (MHz).

The AC power line can broadcast communication signals. This can create noise, which may interfere with other communication signals. If the communication signal strength is too low, the level of noise on the line will overpower the signal. If the communication signal is strong and is a very high frequency, the power line may begin to radiate and thus violate government regulations regarding interference and harmful radiation levels.

Moreover, many RF signal sources, such as cable TV boxes, include power supplies that generate unwanted noise on the AC power line. Hence, much of the noise that comes into a conventional PLC system comes from the very source of the signals the PLC is attempting to transmit.

In view of the foregoing, what is needed is a PLC system which uses the AC power line of a building as a transmission medium in such manner that RF signals are transmitted through the medium and recovered at any point in the AC line. Preferably such a system would not generate unwanted signals and would have high noise immunity. The system preferably would make the AC line transparent. Additionally, the system should be capable of being produced at a low cost in order to allow both industrial and home consumers to economically purchase and use the system.

### SUMMARY OF THE INVENTION

The present invention addresses these needs by providing a system capable of sending and receiving RF signals from 1 to 900 MHz using the AC power line as a transparent transmission medium. The system includes a transmitter circuit to couple the input RF signal to the hot and neutral wires of a three wire AC power line and a receiver circuit to receive the RF signal on the power line and to provide the RF signal as an output. The transmitter circuit includes filtering elements for filtering the input RF signal, an amplifier stage for amplifying the RF signal and a toroid transformer for coupling the filtered and amplified RF signal to the AC power line. The receiver circuit includes passive components for receiving the RF signal on the power line and outputting the RF signal.

Advantageously, the present invention is compatible with the notion of a single network for a variety of electronic devices using the power line for connectivity. Such electronic devices include computers, computer peripherals, telephones, TV systems, audio systems, Internet access devices, controllers for home automation systems and appliances.

### BRIEF DESCRIPTION OF THE DRAWINGS

The invention, together with further advantages thereof, may best be understood by reference to the following description taken in conjunction with the accompanying drawings in which:

FIG. 1A is a schematic representation of a PLC system architecture, in accordance with an embodiment of the present invention;

FIG. 1B is schematic diagram showing a PLC system, in accordance with an embodiment of the present invention;

FIG. 1C is a block diagram showing a three-stage amplifier, in accordance with one embodiment of the present invention;

FIG. 2A is a schematic representation of a transmitter circuit, in accordance with another embodiment of the present invention;

FIG. 2B is a schematic diagram illustrating a transmitter, in accordance with another embodiment of the present invention;

FIG. 3 is a schematic representation of a receiver circuit, in accordance with an aspect of the present invention;

FIG. 4 is a schematic diagram illustrating a balanced to unbalance transmission line interface (Balun) receiver circuit 400, in accordance with another aspect of the present invention;

FIG. 5A is an illustration showing a coaxial cable used as an AC power line;

FIG. 5B is an illustration showing a coaxial cable including a grounded conduit as used by the cable television industry;

FIG. 6 is an illustration showing a transmitter configuration, in accordance with an embodiment of the present invention; and

FIG. 7 is an illustration showing a receiver configuration, in accordance with an embodiment of the present invention.

### DETAILED DESCRIPTION OF THE INVENTION

Disclosed is a PLC system for sending RF signals from 1 to 900 Mhz using the AC power line as a transparent transmission medium. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

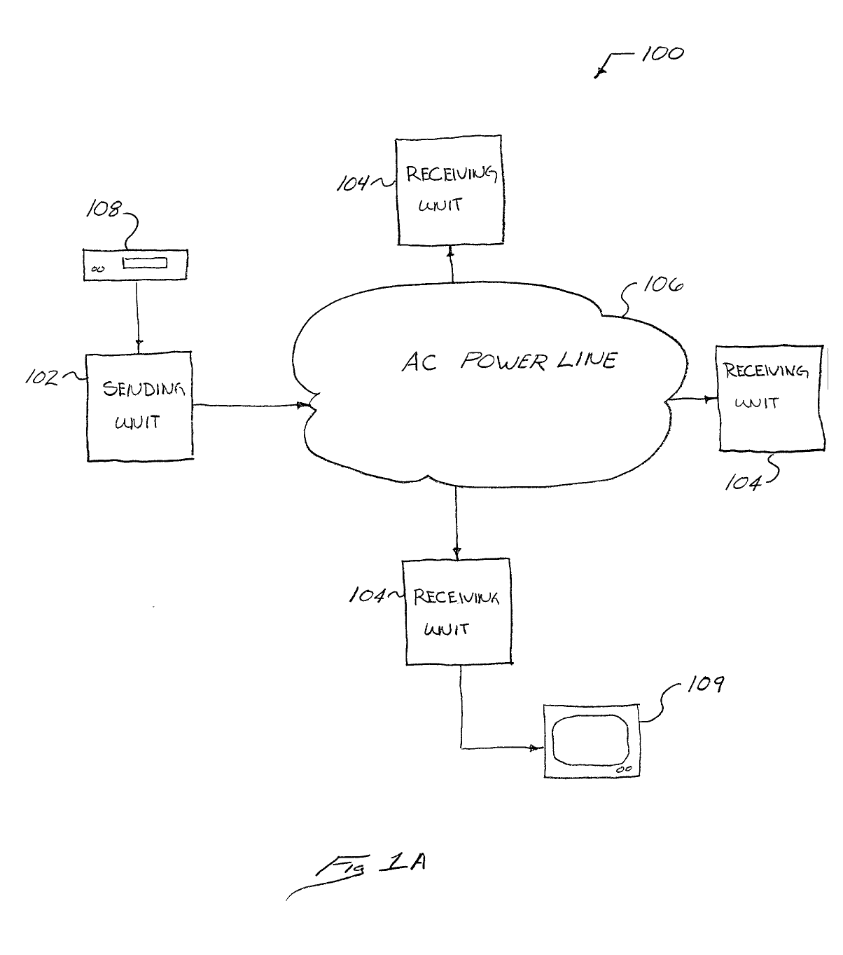

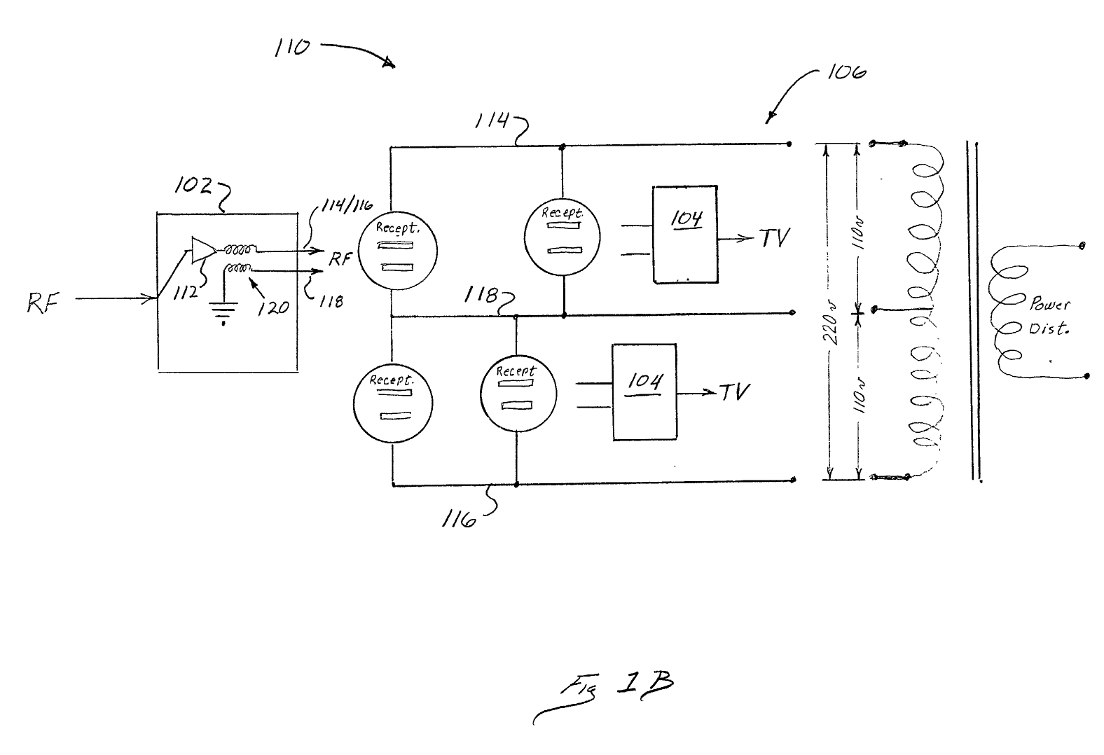

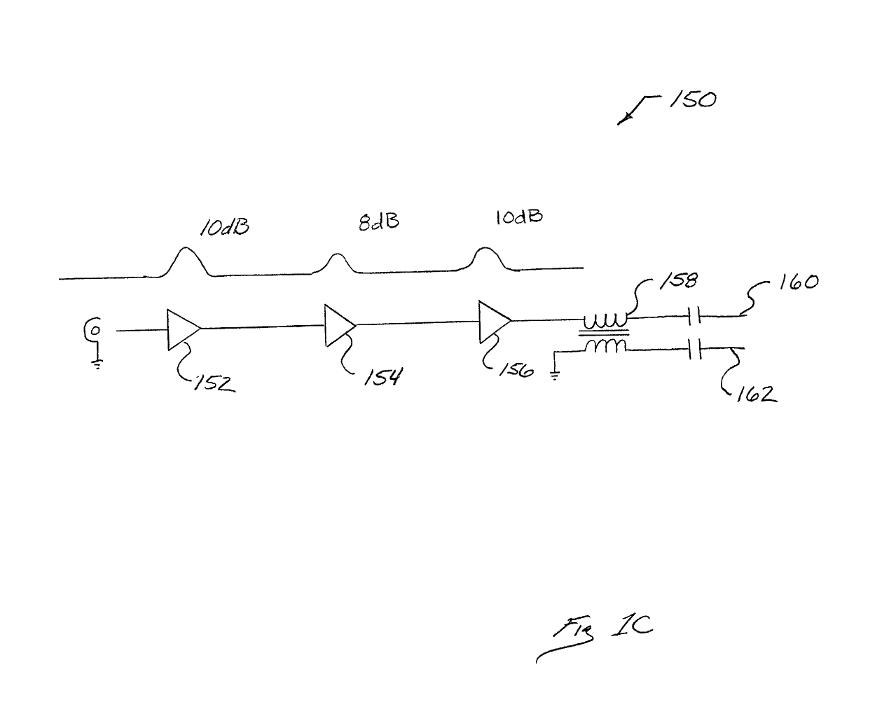

FIGS. 1A-1C graphically depict an overview of the PLC of the present invention. FIG. 1A is a block diagram showing a power line communication system (PLC) 100, in accordance with a preferred embodiment. The PLC 100 includes a sending unit 102, several receiving units 104, and an AC power line 106. In operation, a RF source 108, such as a VCR, provides a RF signal to the sending unit 102 which transmits the RF signal on the AC power line 106. The RF signal is then received by the various receiving units 104, which provide the signal to receiving devices 109 that process the signal, such as televisions.

The disclosed PLC system treats the AC power line as a transparent transmission medium as opposed to a point-to-point transmission line. The input RF signal is not tuned to the AC power line by the sending unit 102 thereby avoiding standing wave problems associated with the AC power line. In fact, the disclosed PLC system relies upon reflection of the RF signal and the power line signal. As long as the reflected RF signals to do not cancel each other out, the RF signal will always appear on the AC power line. Moreover, since there are typically many signal reflections on the AC power line, there is very little chance of the signal being cancelled out.

Even if the amplitude of the RF signal is significantly reduced in the AC power line, it will almost always be greater than zero. Since a typical television can operate on a signal as low as 3 μV, the disclosed system generally will always provide an output RF signal of sufficient magnitude for a typical television to use. Thus, standing waves generally do not pose a problem for the disclosed system.

FIG. 1B is schematic diagram showing a PLC system 110, in accordance with an embodiment of the present invention. The PLC system 110 includes a sending unit 102, a receiving unit 104, and an AC power line 106. In operation, a RF signal enters the sending unit and is passed to an amplifier 112, which amplifies and passes the signal to the AC power line 106.

The AC power line 106 includes a first Hot line 114, a second Hot line 116, and a Neutral line 118. Generally, each power outlet is coupled to the Neutral line 118 and to either the first Hot line 114, or the second Hot line 116. The Hot line (114, 116) is connected throughout a house from outlet to outlet from the AC power line service drop to the building. The Neutral line 118 is normally grounded throughout the AC power line 106 of the house, usually at multiple outlets or strategic points. The Neutral line 118 may be grounded but it can still be effective to the propagation of the RF signal through the AC power lines depending on how the outlet of the PLC circuitry is connected to the AC power output.

The present invention provides a RF signal to the Hot line that is coupled to the power output that the PLC is currently coupled to, either the first Hot line 114 or the second Hot line 116. In addition, the present invention utilizes a transformer 120 to induce a current on the Neutral line 118. Thus, the present invention provides two signals to the AC power line system. Advantageously, providing the RF signal to both the Neutral line 118 and a Hot line reduces the amount of power needed to drive the system, as explained in greater detail subsequently.

FIG. 1C is a block diagram showing a three-stage amplifier 150 used in a sending unit, in accordance with one embodiment of the present invention. The amplifier 150 includes a first amplifier stage 152 having a gain of about 8 db, a second amplifier stage 154 having a gain of about 6 db, and a third amplifier stage 156 having a gain of about 8 db.

In operation, the first stage amplifier 152 acts a signal amplifier. As discussed in greater detail later, the bias network for the first amplifier stage 152 is preferably isolated from the bias networks in succeeding amplifier stages. Isolating the biasing voltages reduces the potential hazard of having any RF signal from the succeeding amplifier stages looping back to the input circuit causing null nodes or instability in the overall performance of the PLC circuit, thus creating undesired oscillations. One method to counter such occurrences is the simple inclusion of a single turn of copper wire on a ferrite bead at the input to the first stage amplifier 152.

The second amplifier stage 154 is biased to provide a lower gain of approximately 6 db, which provides an attenuated path to any RF signal passing from the output of the PLC system, even from any path from the last output stage. The gain suffices to drive the third amplifier stage 156. One concern in the circuit of the present invention is unwanted RF signals in areas that would make the overall function and performance of the system unstable or noisy.

The third amplifier stage 156 is used primarily as a current amplifier. To improve performance, the output of the third amplifier stage 156 may be filtered using a simply SAW or Ceramic resonator designed as a bandpass filter for any desired RF frequency from 10 Mhz to 2 Ghz. The input impedance of this filter is 50 to 75 ohms and the output impedance is 150 to 200 ohms preferably midrange to accommodate any new sensing circuits connected to the output of the PLC system.

Preferably, all amplifiers for the above stages Millimeter integrated circuits (MMICs). Preferably, the first amplifier stage 152 and the second amplifier stage 154 are high frequency, high gain, broadband MMIC signal amplifier devices from 50 Mhz to 2 Ghz bandwidth. In addition, the third amplifier stage 156 is preferably a high frequency, high gain current, MMIC power amplifier device from 50 Mhz to 2 Ghz bandwidth.

A toroidial transformer 158 is coupled to the output of the third amplifier stage 156 to provide a signal to both the Hot AC power line 160 and the Neutral AC power line 162. The toroidial transformer 158 feeds the chaotic conditions of the AC power line environment with a clean current RF signal on both the Hot 160 and the Neutral 162 lines of the physical AC power wiring. Hence, the present invention can operate on effectively half the power normally required because the RF signal produced by the present invention travels along two separate lines. In addition, the toroidial transformer 158 controls the potential hazardous VSWR from the line back to the PLC system output, as described in greater detail subsequently.

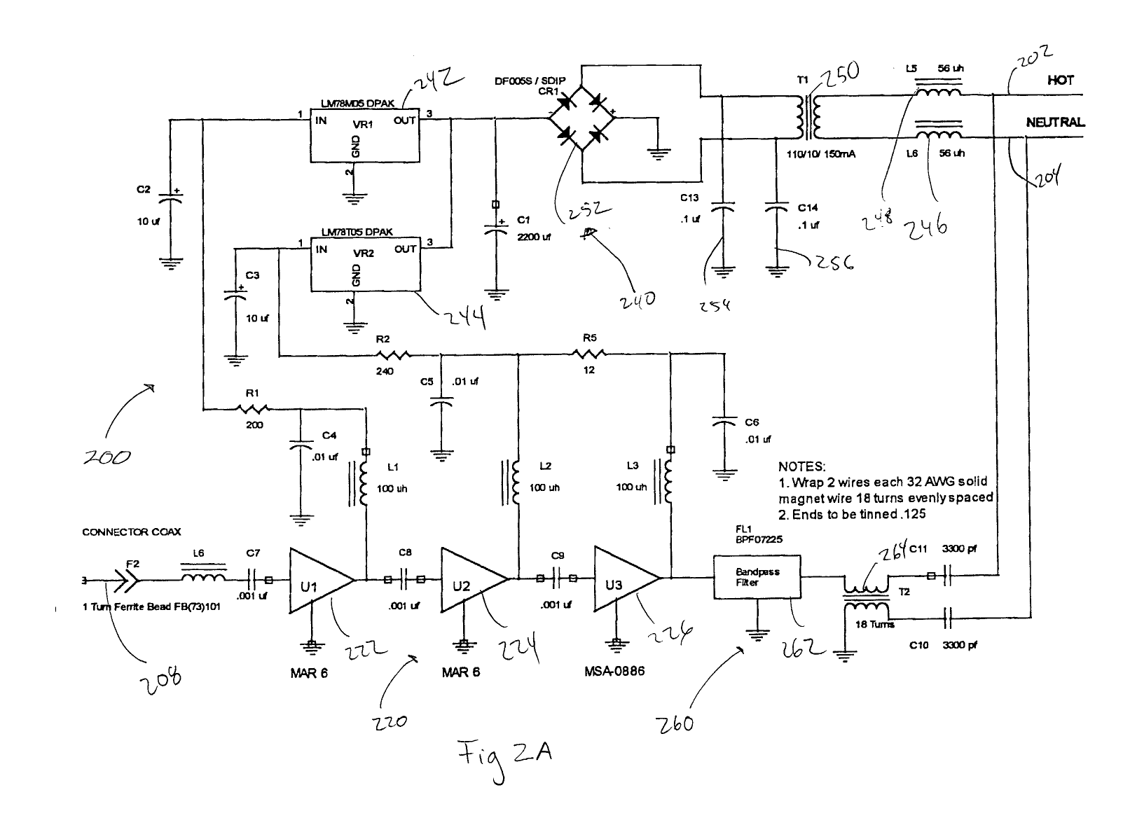

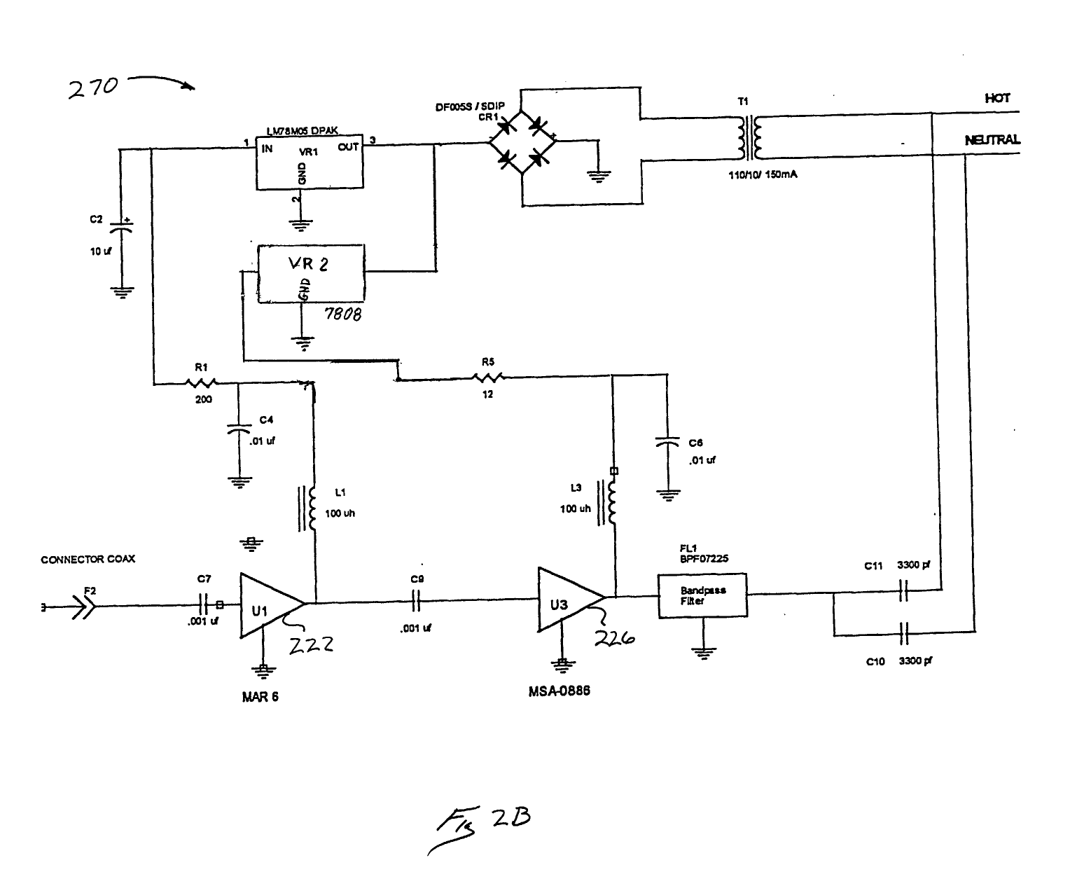

FIG. 2A is schematic diagram showing a transmitter circuit 200 for a sending unit, in accordance with an embodiment of the present invention. The transmitter circuit 200 comprises an amplifier stage generally designated 220, a power supply circuit generally designated 240 and a RF signal coupling circuit generally designated 260. The transmitter circuit 200 is powered by a three line AC power line having a hot line 202 and a neutral line 204. The ground line (not shown) is not used by the PLC system as it is generally the noisiest point in the AC power line. The hot line 202 is connected throughout a building from outlet to outlet from the AC power line service drop to the building. The neutral line 204 is normally grounded throughout the AC power line of the building, usually at multiple outlets or strategic points. Although grounded, the neutral line 204 is effective as a transmission line for the RF signal as it appears as an inductor to the RF signal.

With continued reference to FIG. 2A, an input RF signal is coupled to the transmitter circuit 200 at 208 through ferrite bead inductor L6. Ferrite bead inductor L6 chokes the high frequency RF noise from the signal source from the input RF signal. All DC level signals are blocked by capacitor C7 coupled in series to ferrite bead inductor L6. The input RF signal is amplified by the amplifier stage 220. The amplifier stage 220 includes capacitively coupled amplifiers including a first amplifier stage 222 with a gain of about 8 dB, a second amplifier stage 224 with a gain of about 6 dB and a third amplifier stage 226 with a gain of about 8 db. The first stage amplifier 222 acts a signal amplifier. As discussed in greater detail later, a bias network 242 for the first amplifier stage 222 is preferably isolated from a bias network 244 for the succeeding amplifier stages 224 and 226. Isolating the biasing voltages reduces the potential hazard of having any RF signal from the succeeding amplifier stages 224 and 226 feeding back to the first amplifier stage 222 thereby causing null nodes or regenerative oscillations in the transmitter circuit 220.

The second amplifier stage 224 is biased by bias circuit 244 to provide a lower gain of approximately 6 db and provides isolation between the first amplifier stage 222 and the third amplifier stage 226. The third amplifier stage 226 is a current amplifier having a gain of about 8 dB. The output of the third amplifier stage 226 is coupled to a bandpass filter 262 of the coupling circuit 260. The bandpass filter 262 is preferably implemented as a SAW or Ceramic resonator having a range from 1 to 900 MHz. The input impedance of filter 262 is 50 to 75 ohms and the output impedance is from 150 to 200 ohms. Preferably the output impedance is in the midrange to accommodate additional receiving units connected to the AC power line.

Preferably, the amplifiers 222, 224 and 226 are millimeter integrated circuits (MMICs). Also preferably, the amplifiers 222 and 224 are high frequency (50 MHz to 2GHz), high gain, broadband MMIC signal amplifier devices. The third amplifier stage 226 is preferably a high frequency, high gain current amplifier.

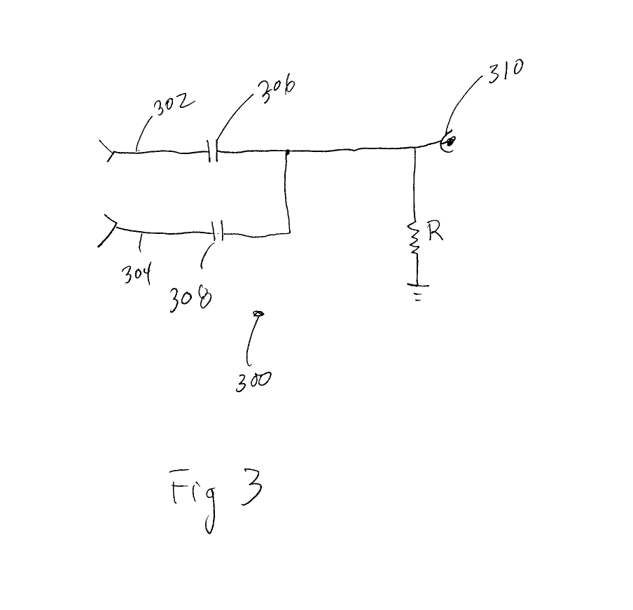

The coupling circuit 260 further includes a toroid transformer 264 for coupling the RF signal output by the amplifier stage 220 to the hot line 202 and the neutral line 204 of the AC power line. A primary winding of the toroid transformer 264 is capacitively coupled to and feeds the RF signal to the hot line 202. The secondary winding is capacitively coupled to and feeds the RF signal to the neutral line 204. The hot line 202 and the neutral line 204 thus have the same RF signal with a very slight phase delta between the two signals. Ensuring that the hot line 202 and the neutral line 204 provide equal RF signals ensures that a signal from either line can be received by the receiver circuit 300 (FIG. 3). In this manner the required power can be reduced to half the power which reduces circuit generated noise from the transmitting circuit 220.

The power supply circuit 240 is fed by the same AC line. Inductors 246 and 248 choke any high frequency components of the AC power line and specifically the RF signal output of the toroid transformer 264. These high frequency components include those components responsible for the “rolling bars” seen on television screens. A step down transformer 250 steps down the AC voltage to about 10 volts for subsequent rectification by bridge 252. Capacitors 254 and 256 further shunt high frequency components to ground. The output of the bridge 252 is coupled to a first bias network 242 and a second bias network 244. The first bias network 242 is coupled to the first stage amplifier 22 and the second bias network 244 is coupled to the second and third amplifier stages 224 and 226. The first stage amplifier 222 is bias separately from the second and third stages 224 and 226 so that signals developed by the second the third stages 224 and 226 are not fed back to the first stage amplifier 222. Regenerative instability is thereby eliminated. The remaining passive components of the first bias network 242 and the second bias network 244 choke and shunt to ground undesirable AC components and provide proper bias voltages to the first, second and third amplifier stages.

As stated previously, the RF chokes to the AC power line that are in line with the AC power source and the step down power transformer, choke out the RF feedback fed to the AC power line. As an alternate embodiment, these inductors may be removed to reduce production cost. However, if the RF signal is not reduced substantially before reaching the power transformer, the RF signal may radiate all over the small space of the circuit.

In yet a further embodiment, the toroid transformer may be removed. In this embodiment, the two capacitors are connected to the AC power line together. Alternatively, the two capacitors may be connected to a center tap version of the transformer. The center tapped transformer has opposing outputs from center out to the hot and neutral AC power lines. Unless the secondary winding has opposing turns from the center tap, this method only reduces the amount of output signal.

FIG. 2B is a schematic diagram illustrating a transmitter 270, in accordance with another embodiment of the present invention. To reduce production cost, the transmitter 270 couples the first amplifier stage 222 to the third amplifier stage 226 via capacitor C9.

As discussed above, the elimination of the second amplifier stage 224 of FIG. 2A reduces production cost. However, in this embodiment the ability of the transmitter 270 to amplify the input signal is diminished. Therefore, the gain requirements for the first amplifier stage 222 and the third amplifier stage 226 are increased. The gain generally must be increased in a fashion to optimize the two cascaded amplifiers. This increase in gain makes the transmitter 270 nosier than that of FIG. 2A because the current increase per each device must also proportionately increase the noise per device throughout the entire circuit.

Unlike most conventional amplifier circuits, the output of the transmitter 270 of FIG. 2B is fed back to the AC power line, which supplies the AC power source to the DC power supply to the amplifier. Conventionally, amplifiers are designed to connect to a coax or other more conventional transmission line, and the low voltage power supply for the circuit is isolated as much as possible from the RFI/EMI riding on the AC power line.

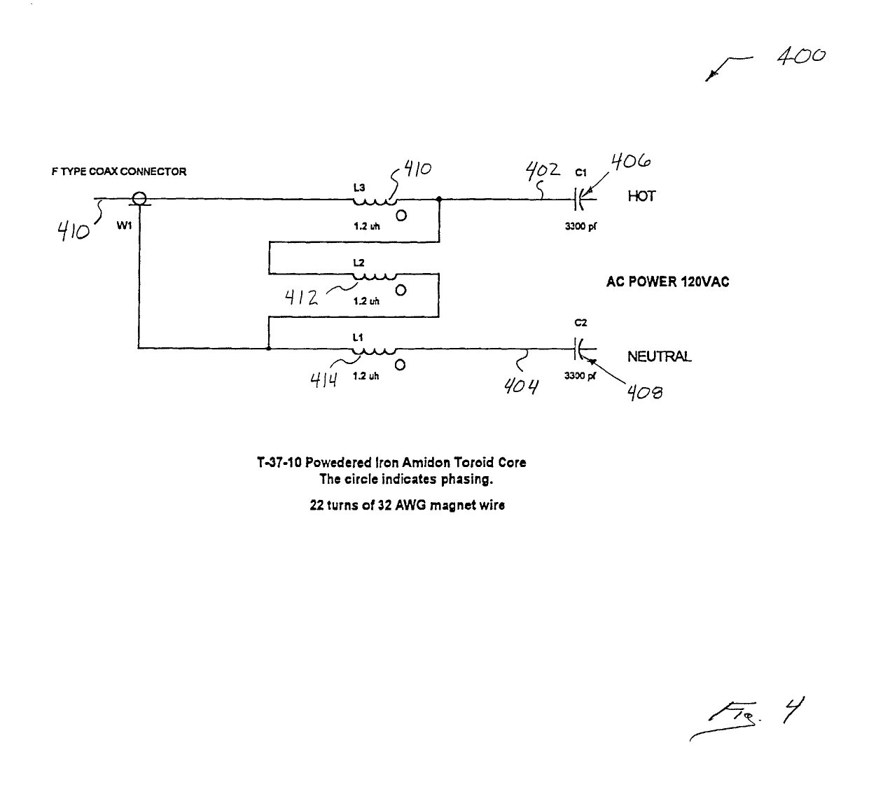

With reference to FIG. 3 there is shown a receiver circuit 300, in accordance with an embodiment of the present invention. Lines 302 and 304 are operatively coupled to hot line 202 and neutral line 204 of the AC power line. Capacitors 306 and 308 are tuned capacitors to detect the desired RF frequency fed to the AC line by the transmitter circuit 220. The detected RF signal is coupled to cable 310 for input to a device for processing the RF signal such as a television or computer processor. It should be borne in mind that other forms of receivers are possible for use with the present invention, as shown with reference to FIG. 4 below.

FIG. 4 is a schematic diagram illustrating a balanced to unbalance transmission line interface (Balun) receiver circuit 400, in accordance with another embodiment of the present invention. The receiver circuit 400 includes lines 402 and 404 operatively coupled to hot line and neutral line of the AC power line. Capacitors 406 and 408 are tuned capacitors to detect the desired RF frequency provided to the AC power line by the transmitter circuit. The receiver circuit 400 further includes inductors 410, 412, and 414. In use, the detected RF signal is coupled to cable 414 for input to a device for processing the RF signal such as a television or computer processor. Advantageously, the Balun easily passes the RF signal from both the hot and the Neutral AC power lines to the television or computer receiver. Preferably, the Balun is 200 ohm to 75 ohm network wound on a toroid core to 22 turns 32 AWG magnet wire in trifilar form. Also advantageously, both the receiver of FIG. 3 and the receiver of FIG. 4 require no demodulation circuitry, and are thus passive receivers.

To illustrate one application of the present invention, an example will be provided illustrating the present inventions use with a RF signal originating in a video cassette recorder (“VCR”). The destination of the signal will be a standard television, although the source may be any RF source of 50 to 600 MHz and the destination may be any component capable of interpreting the signal. Similarly, the RF signal is assumed to be a channel 3 signal, which is a standard output for VCRs in North America, although any channel within the aforementioned frequency range can be utilized.

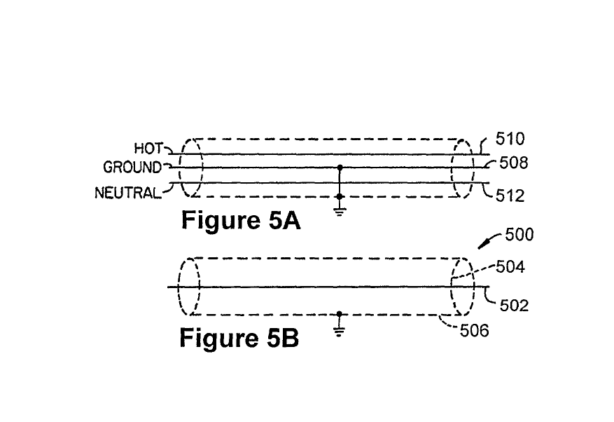

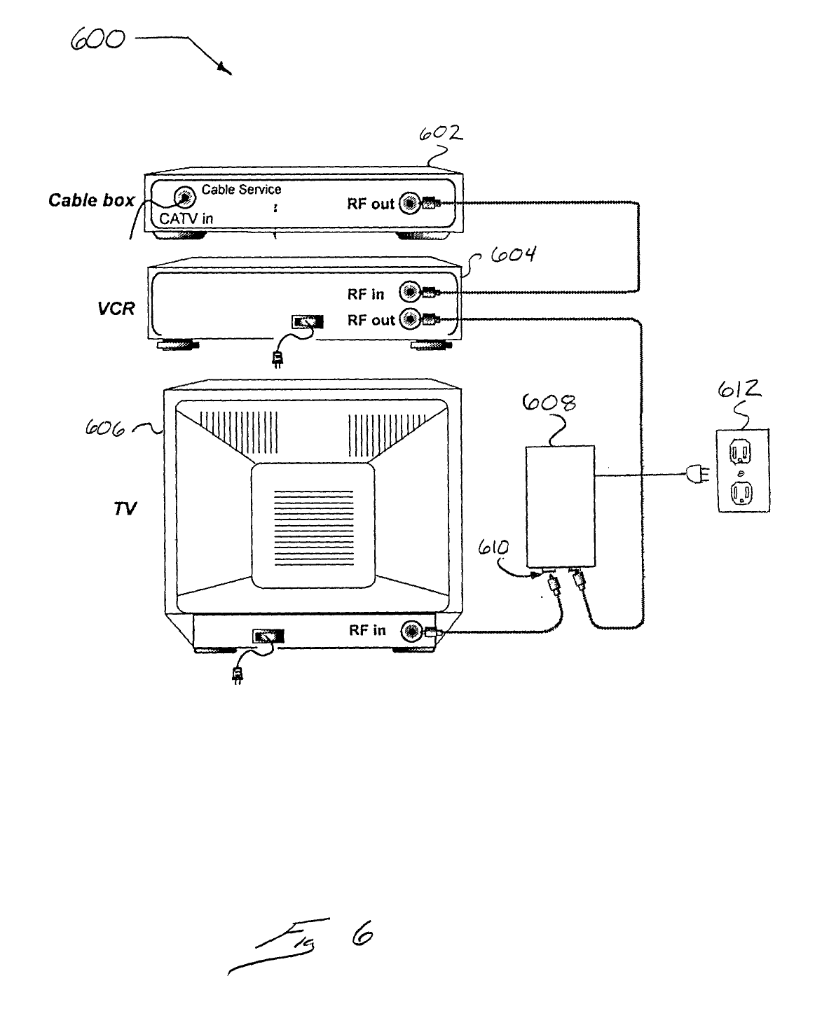

FIGS. 5A and 5B illustrate coax cables suitable for use with the present invention. Referring to FIG. 5B the coax cable generally illustrated at 500 comprises a centrally located conductor 502 typically insulated by a teflon layer 504 and shielded by a woven conductive ground layer 506 and a protective plastic coating (not shown). The AC power distribution line of FIG. 5A includes a grounded conduit 508 which functions as a shield to the two active conductors in the AC line 510, 512 which are the hot and neutral conductors, respectively. The dielectric between the lines 510, 512 inside the conduit 508 is a plastic insulation (not shown) while the dielectric between the inside conductors and the conduit shield is air unlike the teflon insulation used in coax or triax.

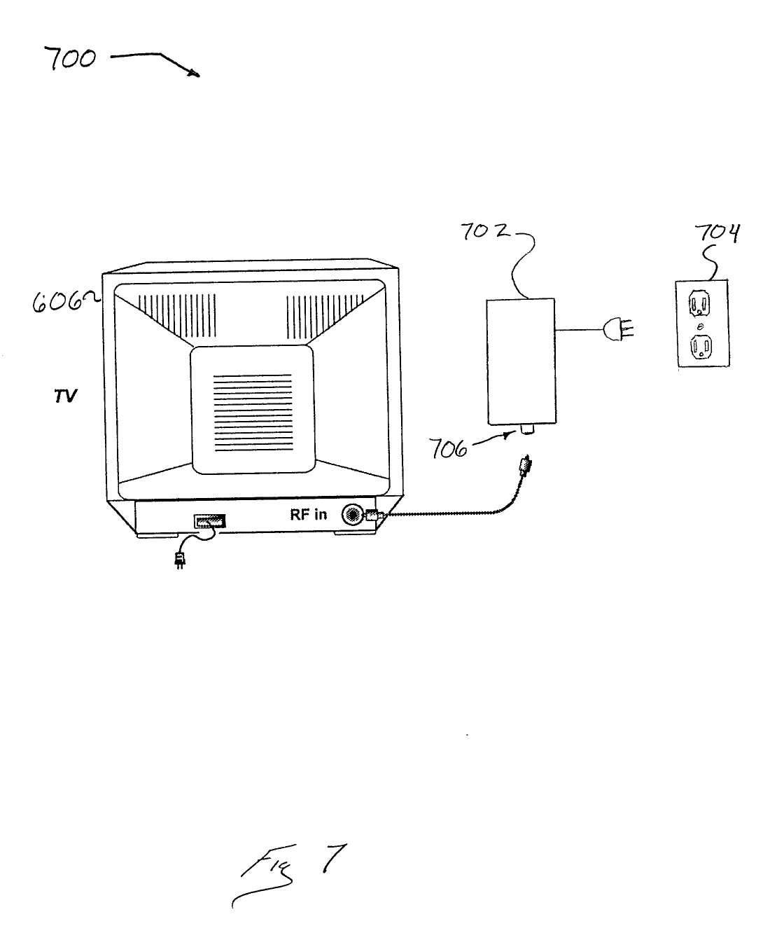

FIG. 6 is an illustration showing a transmitter configuration 600, in accordance with an embodiment of the present invention. The transmitter configuration includes an RF source 602, such as a cable box or antenna, an auxiliary component 604, such as a VCR, a television 606, and a transmitter 608.

In operation, the RF source 602 provides an RF signal to transmitter 608. In route to the transmitter 608, the RF signal may also be provided to the VCR 604 and the television 606. Typically, the RF signal is transmitted via a coax cable to the auxiliary component 604, in this case a VCR, and from there to the transmitter 608. Preferably, the transmitter 608 is capable of providing the RF signal to additional components, such as the television 606, using a coax RF out 610. The transmitter 608 then transmits the RF signal to the AC power line via power outlet 612. The RF signal thereby enters the AC wiring system of the building to be received by a receiver, as discussed in greater detail subsequently.

FIG. 7 is an illustration showing a receiver configuration 700, in accordance with an embodiment of the present invention. The receiver configuration 700 includes a receiver 702 and a display device 606, such as a television.

When the transmitter provides the RF signal to the AC power line, the receiver 702 receives the RF signal via the power outlet 704. The receiver 702 then provides the RF signal to the television 606 via a coax RF output 706.

While the present invention has been described in terms of several preferred embodiments, there are many alterations, permutations, and equivalents which may fall within the scope of the present invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A circuit for communication of an RF signal over an AC power line medium comprising:
a transmitter to transmit the RF signal over the AC power line medium, the transmitter being capable of transmitting the RF signal over the AC power line in a range of about 1 Mhz to 900 Mhz; and
a receiver to receive the RF signal from the AC power line medium.

2. A circuit as claimed in claim 1 wherein the transmitter is powered by the AC power line,

3. A circuit as claimed in claim 1 wherein the receiver is a passive receiver.

4. A circuit as claimed in claim 1 wherein the transmitter further comprises a first stage, a second stage, and a third stage operatively coupled one to the other.

5. A circuit as claimed in claim 4 wherein the first stage further comprises a ferrite bead inductor coupled to a capacitor.

6. A circuit as claimed in claim 4 wherein the second stage further comprises a first signal amplifier, a second signal amplifier, and a signal current amplifier operatively coupled one to the other, wherein the second signal amplifier and the signal current amplifier are isolated from the first signal amplifier.

7. A circuit as claimed in claim 6 wherein the first signal amplifier, the second isolation signal amplifier and the signal current amplifier are MMIC devices.

8. A circuit as claimed in claim 6 wherein the third stage further comprises a bandpass filter coupled to an output of the signal current amplifier and a toroid transformer coupled to an output of the bandpass filter.

9. A method for transmitting an RF signal over an AC power line medium comprising:
transmitting an RF signal in a range of about 1 Mhz to 900 Mhz over an AC power line medium utilizing a transmitter; and
receiving the RF signal from the AC power line medium via a receiver.

10. A method as recited in claim 9 wherein the receiver is a passive receiver.

11. A method as recited in claim 9 wherein the transmitter further comprises a first stage, an second stage and a third stage operatively coupled one to the other.

12. A method as recited in claim 11 wherein the first stage further comprises a ferrite bead inductor coupled to a capacitor.

13. A method as recited in claim 11 wherein the second stage further comprises a first signal amplifier, a second signal amplifier, and a signal current amplifier operatively coupled one to the other, wherein the second signal amplifier and the signal current amplifier are isolated from the first signal amplifier.

14. A method as recited in claim 13 wherein the first signal amplifier, the second isolation signal amplifier and the signal current amplifier are MMIC devices.

15. A method as recited in claim 13 wherein the third stage further comprises a bandpass filter coupled to an output of the signal current amplifier and a toroid transformer coupled to an output of the bandpass filter.

16. A transmitter for transmitting an RF signal over an AC power line without tuning the RF signal to the AC power line, the transmitter comprising:
a first signal amplifier stage coupled to a first bias network for amplifying an input signal; and
a third current amplifier stage coupled to a third bias network, the third bias network being isolated from the first bias network, the third current amplifier operational to increase current provided to the AC power line.

17. A transmitter as recited in claim 16, further including a second signal amplifier stage coupled the first signal amplifier, wherein the second signal amplifier is further coupled to the third bias network, the second signal amplifier stage operational to reduce output reflectivity.

18. A transmitter as recited in claim 17, wherein output circuitry of the transmitter is mismatched to produce standing waves.

19. A transmitter as recited in claim 17, wherein a gain of the second amplifier stage is less than a gain of the first amplifier stage and the third amplifier stage.

20. A transmitter as recited in claim 17, wherein the transmitter transmits the RF signal over the AC power line utilizing a hot power line and a neutral power line, whereby probability of good reception is increased.
